(19) United States
(12) Patent Application Publication
(10) Pub. No.: US 2011/0278031 A1
(43) Pub. Date: Nov. 17, 2011

(54) TINE

(76) Inventors: Mitsuharu Kobayashi, Niigata (JP); Katumi Tsukada, Gunma (JP)

(21) Appl. No.: 13/146,127

(22) PCT Filed: Aug. 12, 2009
(86) PCT No.: PCT/JP2009/064236

§ 371 Date: Jul. 25, 2011

(30) Foreign Application Priority Data
Jan. 23, 2009 (JP) 2009-012436

(51) Int. Cl. A01B 45/02

(52) U.S. Cl. 172/22

(57) ABSTRACT

A conventional tine used for management of a broad expanse of grass is manufactured by cutting a long hole-shaped opening in the middle portion of a pipe. As a result, the width of the opening is narrower than the diameter of the pipe, a plug resulting when a tip of the tine bores a hole in the grass does not easily drop out from the opening, and the tine is easily clogged. A tine according to the present invention includes a hollow cylindrical tip insertion (11) that is tapered and becomes thinner as it approaches the tip, a base grip (12) apart from the tip insertion (11), and a connection (13) for connecting between the tip insertion (11) and the base grip (12), wherein the connection (13) includes an aperture (15), and the aperture (15) has a circumferential angle of 180 degrees or greater centered around the central axis a of a virtual hollow cylinder (17), which is formed by extending the maximum diameter portion of the tip insertion (11) toward the base grip (12).

### TECHNICAL FIELD

The present invention relates to a tine to be attached to a mounting part of an aeration device used in grass cultivation management.

### BACKGROUND ART

Root cutting of moderately severing overgrown roots in cultivation management of a vast area of grass such as a golf course is carried out. Patent Document 1 gives an example of carrying out this operation. A tine, which has a pointed edge formed on a tip insertion having an approximate cross-shaped cross section and a cross-sectional area that becomes smaller as it approaches the tip, is used as a tool for this root cutting. Thrusting such a tine into soil cuts grass roots.

However, since grass does not sufficiently grow only by root-cutting, a coring operation of facilitating passing of air to the grass roots is carried out. This coring operation opens air holes in the ground using a tubular tine attached to an aeration device (e.g., Patent Document 2).

When the tine main body is thrust into the ground, soil gets into the tine main body from an open end of the tip, becoming a clod (referred to as ‘plug’). This plug progresses into the tine and is then ejected to the outside from an aperture formed in the tine main body when the tine main body is extracted from the ground and the tine is then thrust therein. This tine is capable of root cutting due to its pointy forefront open-end edge. Furthermore, as a hole corresponding to the grass plug is formed, coring may be carried out simultaneously.

### PRIOR ART DOCUMENTS

### PATENT DOCUMENTS

Patent Document 1: JP H11-009006 A

Patent Document 2: JP 2007-49923 A

### DISCLOSURE OF INVENTION

### Problem to be Solved by the Invention

However, the tine of Patent Document 2 has the following problem. While the tine main body is formed in a pipe shape and the aperture of the tine is formed such that the middle section of the pipe is a cut-out long hole, the width of the long hole is smaller than the diameter of the pipe, only opened a third or a fourth of the entire circumference. This is because strength of the tine main body will decrease if the width of the aperture is greater than the diameter. Therefore, the aperture cannot be enlarged, and it is difficult to extract the plug from the aperture and the tine is easily clogged.

The present invention has been proposed to resolve this problem, and an object thereof is to provide a tine allowing simultaneous root cutting and boring with sufficient strength and easy plug extraction.

### MEANS OF SOLVING THE PROBLEM

In order to achieve the above object, a tine according to the present invention is characterized by including: a hollow cylindrical tip insertion that is tapered and becomes thinner as it approaches the tip, a base grip apart from the tip insertion, and a connection for connecting between the tip insertion and the base grip; wherein the connection comprises an aperture, and the aperture has, at the position of a virtual hollow cylinder having a maximum diameter portion of the tip insertion extending toward the base grip, a circumferential angle of 180 degrees or greater centered around the central axis of the virtual hollow cylinder.

The connection may be made up of a part of a hollow cylinder connecting between the maximum diameter portion of the tip insertion and the base grip and a reinforcement added to the hollow cylinder; the connection may be made by thickening the wall of a portion of a hollow cylinder connecting between the maximum diameter portion of the tip insertion and the base grip; the connection may be made by widening a portion of a hollow cylinder connecting between the maximum diameter portion of the tip insertion and the base grip; the reinforcement may have one or a plurality of ribs on the outside of the inner diameter of the hollow cylinder extending from the central axis of the hollow cylinder outward; and the connection may include a central portion on the outside of the inner diameter of the virtual hollow cylinder connecting between the maximum diameter portion of the tip insertion and the base grip, and one or a plurality of ribs extending radially from the central portion; and the one or plurality of ribs is arranged on the outside of the inner diameter of the virtual hollow cylinder.

### RESULTS OF INVENTION

The tine according to the present invention may be strengthened at liberty since width and thickness of the connecting member may be freely changed, and the aperture size may be increased to prevent clogging of the plug. Furthermore, this sufficiently secures the strength of the connection and lengthens the lifetime of the tine. As a result, this allows fabrication of the connecting member whose width is provided with an circumferential angle of 180 degrees or less centered around the central axis, and the soil (plug) pushed out from the tube of the tip insertion is surely dropped onto the grass from the aperture of the connecting member, hardly ever clogging the tine. Moreover, the connecting member provided with ribs allows further increase in strength of the connecting member as well as effective root cutting, which thereby allows the root cutting operation and the boring operation conventionally carried out separately to be carried out in a single process.

According to the tine of the present invention, formation of the ribs extending to the connecting member in a symmetrical shape makes the tine vibrate less during operation, and reduces the operative load on the aeration device to which the tine is attached.

### BRIEF DESCRIPTION OF DRAWINGS

FIG. 1 is an oblique view of a first embodiment of a tine according to the present invention;

FIG. 2 is a cross-sectional view cut along a line A-A of FIG. 1;

FIG. 3 is a diagram of a second embodiment of the tine according to the present invention corresponding to the cross-sectional view cut along the line A-A of FIG. 1;

FIG. 4 is a diagram of a third embodiment of the tine according to the present invention corresponding to the cross-sectional view cut along the line A-A of FIG. 1;

FIG. 5 is a diagram of a fourth embodiment of the tine according to the present invention corresponding to the cross-sectional view cut along the line A⁻A of FIG. 1;

FIG. 6 is an oblique view of a fifth embodiment of the tine according to the present invention;

FIG. 7 is a cross⁻sectional view cut along a line B-B of FIG. 6;

FIG. 8 is a diagram of a sixth embodiment of the tine according to the present invention corresponding to the cross-sectional view cut along the line B-B of FIG. 6;

FIG. 9 is a diagram of a seventh embodiment of the tine according to the present invention corresponding to the cross-sectional view cut along the line B-B of FIG. 6;

FIG. 10 is a diagram of an eighth embodiment of the tine according to the present invention corresponding to the cross-sectional view cut along the line B-B of FIG. 6; and

FIG. 11 is a diagram of a ninth embodiment of the tine according to the present invention corresponding to the cross-sectional view cut along the line B-B of FIG. 6.

### BEST MODE FOR CARRYING OUT THE INVENTION

Embodiments according to the present invention are described with reference to accompanying drawings forthwith.

### First Embodiment

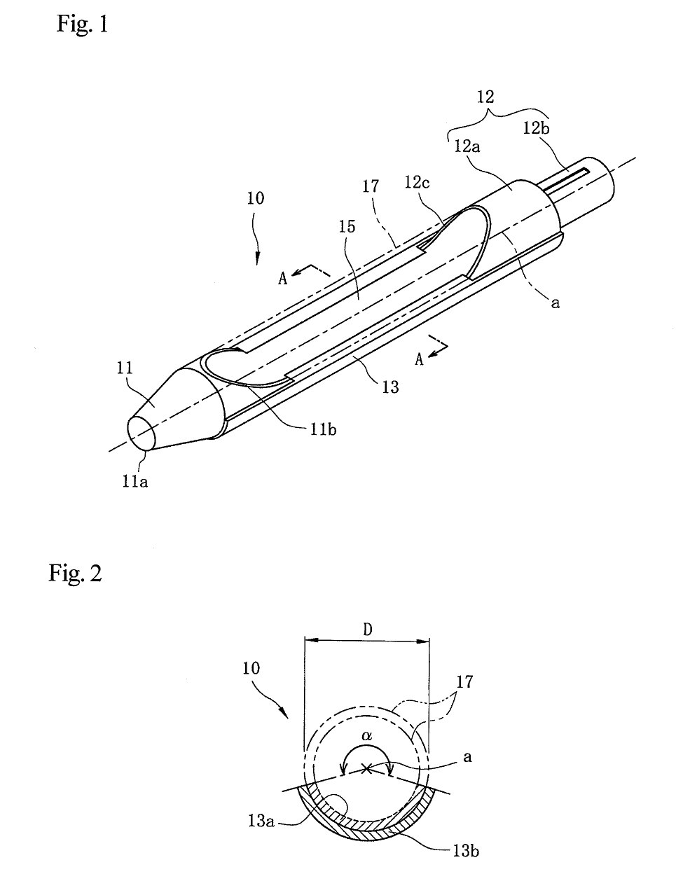

FIG. 1 is an oblique view of a first embodiment of a tine according to the present invention, and FIG. 2 is a cross-sectional view cut along a line A-A of FIG. 1.

As shown in these drawings, a tine 10 of the present invention is constituted by a hollow cylindrical tip insertion 11 that is tapered and becomes thinner as it approaches the tip, a base grip 12 apart from the tip insertion 11, and a connection 13 for connecting therebetween. The base grip 12 is divided into a tubular thick diameter portion 12a having the same diameter as the tip insertion 11 and a thin diameter portion 12b at the rear thereof. Furthermore, the thin diameter portion 12b is gripped by the aeration device.

A front edge 11a of the tip insertion 11 is sharply pointed, facilitating insertion into grass and cutting of grass roots. A back end 11b of the tip insertion 11 is inclined and connected to the connection 13, maintaining the strength of the connecting portion. Similarly, a front end 12c of the base grip 12 is also inclined and smoothly connected to the connection 13. Connecting smoothly in this manner allows prevention of strength reduction.

The tip insertion 11 and the base grip 12 of the tine 10 of FIG. 1 are formed from a single pipe and have the same outer diameter and inner diameter. The original pipe is illustrated as a virtual hollow cylinder 17 with the maximum diameter portion of the tip insertion 11 extending toward the base grip 12 until reaching it. The connection 13 is formed by eliminating a part corresponding to an aperture 15 of this pipe through a cutting operation.

As shown in FIG. 2, the connection 13 is structured by a pipe portion 13a and a reinforcement 13b adhered to the outer side of the pipe portion. A circumferential angle α of an aperture 15 centered around the central axis a of the virtual hollow cylinder 17 is set to 180 degrees or greater. Furthermore, width measured along the circumference of the aperture 15 is greater than the diameter D of the pipe.

In the case of making the tine 10 from the pipe represented by the illustrated virtual hollow cylinder 17 by cutting out the intermediate portion thereof, the tip of the tip insertion 11 shall be narrowed to decrease the diameter. The remaining portion of the pipe at the aperture 15 portion is the connection 13. In this case, when the connection 13 weakens only due to the wall thickness of the pipe, a reinforcement 13b formed of a steel plate is added through welding or the like.

When making the tine 10 by casting, the tip insertion 11 and the base grip 12 must be solid, and they are joined with the connection 13 and then cast into a single body. After formation, a tapered hole shall be bored in the hollow portion of the tip insertion 11 and a hole in the base grip 12, if necessary, shall also be bored. At this time, the thickness of the connection 13 need not be the same as the pipe wall thickness, and is preferably made thicker than the pipe wall thickness so as to provide necessary strength. Furthermore, the cross-sectional shape of the connection 13 may be set at liberty, the outer side is arbitrary such as a pointed triangle, trapezoid, curved or oblong quadrangle, and ribs to be described later may be extended so as to withstand high tension.

The thin diameter portion 12b is attached and fixed, as an attaching portion of the tine 10 with the above described structure, to an attaching portion of the aeration device. When the aeration device to which the tine 10 has been attached is operated, the tine 10 moves up and down, cuts grass roots, and makes a hole for sending air to the grass roots.

The up and down movement of the tine will be further described. Firstly, the tine 10 is moved downward and thrust into the dirt, whereby soil enters a tubular body 1 and grass roots are cut. Next, the tine 10 is moved upward and then moved downward again so as to thrush into the dirt. At this time, new soil is pushed up and compresses the soil within the tubular body 1, creating a plug. This plug is pushed up by new soil, reaching the aperture 15, rolling down from the aperture 15 to the outside of the tine 10, and dropping onto the grass. As a result, the roots of overgrown grass are cut and the holes for sending air to the grass roots are opened. Since root cutting and boring conventionally carried out separately may be carried out in one operation, allowing effective grass cultivation management.

Since the aperture 15 of the conventional tine has a circumferential angle α of less than 180 degrees centered around the central axis a, it is thereby difficult for the soil to exit from the aperture 15, difficult to be dropped outside, and the conventional tine is easily clogged when soil keeps continuing to enter the tine. However, since the aperture 15 of the tine 10 according to the present invention has a circumferential angle of 180 degrees or greater, the plug reliably exits the aperture 15, drops onto the grass, and the tine 10 does not become clogged.

Furthermore, even if the aperture 15 of the tine 10 according to the present invention is set to have a circumferential angle α of 180 degrees or greater since the connection 13 is thick and is reinforced, strength of the tine 10 may be sufficiently maintained.

### Second Embodiment

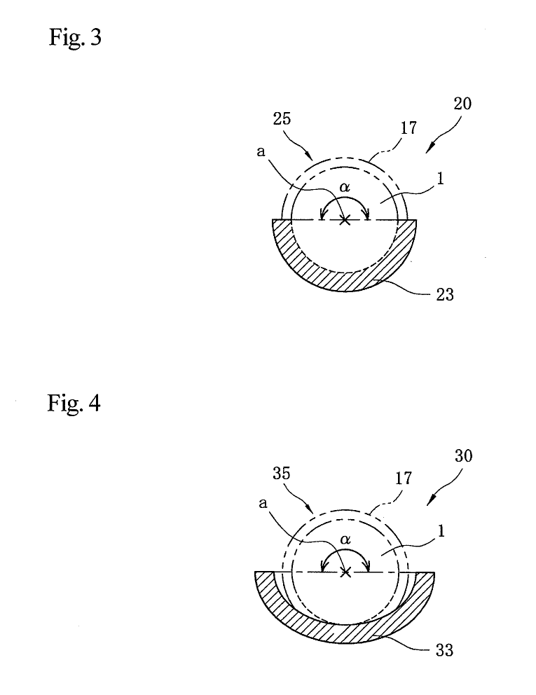

FIG. 3 is a diagram of a second embodiment of the tine according to the present invention, corresponding to the cross-sectional view cut along the line A-A of FIG. 1. A tine 20 shown in this diagram is an example where a connection 23 is formed in a semicircle, and a circumferential angle α of an aperture 25 is set to 180 degrees centered around the central axis a of the virtual hollow cylinder 17. While the connection 13 is constituted by the pipe portion 13a and the reinforcement 13b adhered to the outer side thereof in the first embodiment of FIG. 1, in this case, the pipe portion 13a and the reinforcement 13b are formed into one body as a thick-walled part. Such tine 20 and tines of third through ninth embodiments described below may be manufactured by casting in any case.

### Third Embodiment

FIG. 4 is a diagram of a third embodiment of the tine according to the present invention, corresponding to the cross-sectional view cut along the line A-A of FIG. 1. A connection 33 of a tine 30 shown in this diagram results from pulling and deforming both sides of the connection 23 of FIG. 3 to the outside so as to enlarge an aperture 35.

### Fourth Embodiment

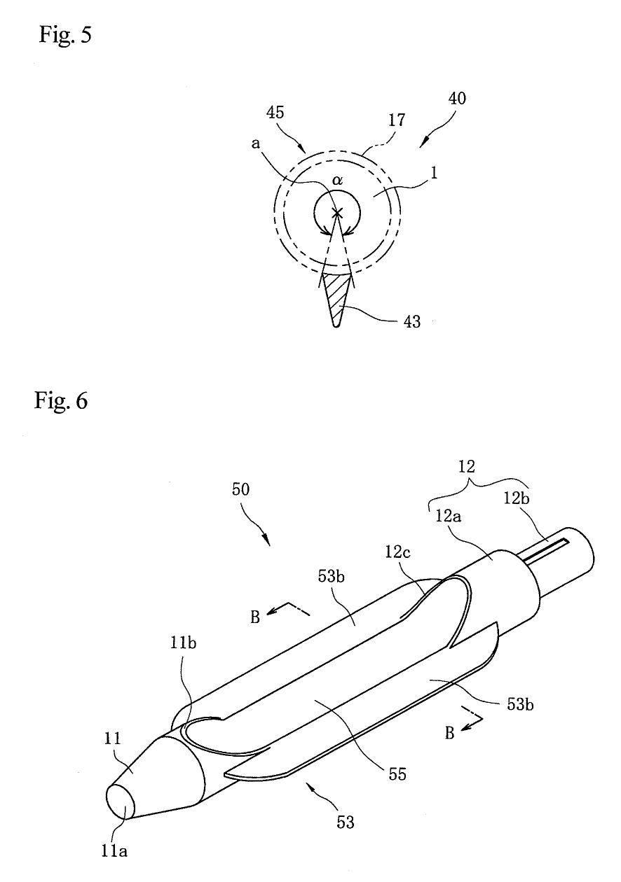

FIG. 5 is a diagram of a fourth embodiment of the tine according to the present invention, corresponding to the cross-sectional view cut along the line A-A of FIG. 1. A connection 43 of a tine 40 shown in this diagram is constituted by a single rib circumscribing the virtual hollow cylinder 17 of the diagram and extending vertically. The rib acting as the connection 43 has a V-shaped cross section and can easily cut grass roots. A circumferential angle α of an aperture 45 is a supplementary angle sandwiching the rib as the connection 43, allowing security of an aperture 45 having a very large circumferential angle α. While the connection 43 circumscribes the outer diameter of the virtual hollow cylinder 17, it may be made to circumscribe the inner diameter.

### Fifth Embodiment

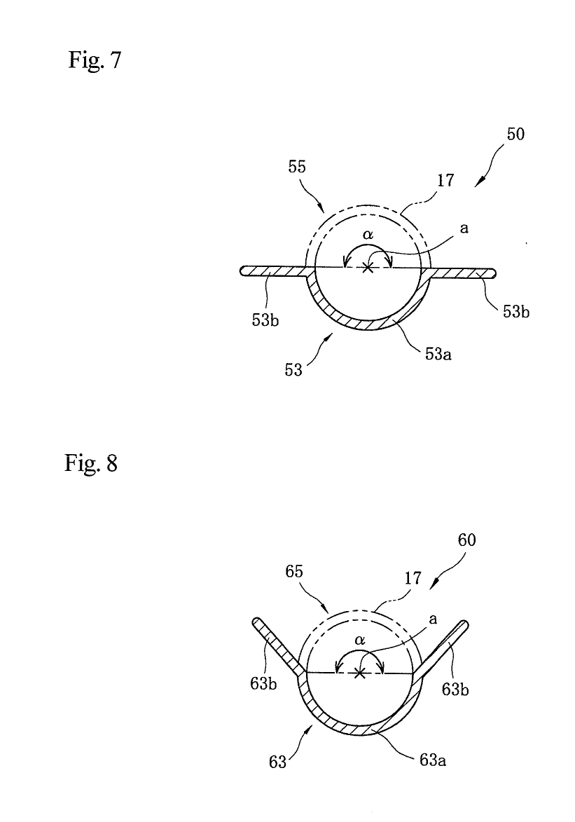

FIG. 6 is an oblique view of a fifth embodiment of a tine according to the present invention, and FIG. 7 is a cross-sectional view cut along a line B-B of FIG. 6. A tine 50 shown in these drawings has the same tip insertion 11 and base grip 12 as the tine 10 of FIG. 1, and they are connected by a connection 53. The connection 53 has ribs 53b and 53b formed on either side of a semicircular arc 53a with a central angle of 180 degrees, as shown in FIG. 7. A circumferential angle α centered around the central axis a of the virtual hollow cylinder 17 at an aperture 55 is set to 180 degrees. This tine 50 has two ribs 53b at the connection 53 and may effectively cut grass roots as a result thereof.

### Sixth Embodiment

FIG. 8 is a diagram of a sixth embodiment of the tine according to the present invention corresponding to the cross-sectional view cut along the line B-B of FIG. 6. A connection 63 of a tine 60 according to this embodiment is formed having ribs 63b and 63b on either end of an arc 63a overlapping the virtual hollow cylinder 17. The ribs 63b and 63b have a V-shape obtained by tilting the ribs 53b and 53b of the embodiment illustrated in FIG. 6. An aperture 65 has a circumferential angle α of 180 degrees at the position of the virtual hollow cylinder 17 centered around the central axis a of the virtual hollow cylinder 17. Since the ribs 63b and 63b are open in a V shape on the outside of the aperture 65, there is no need to narrow the aperture 65.

### Seventh Embodiment

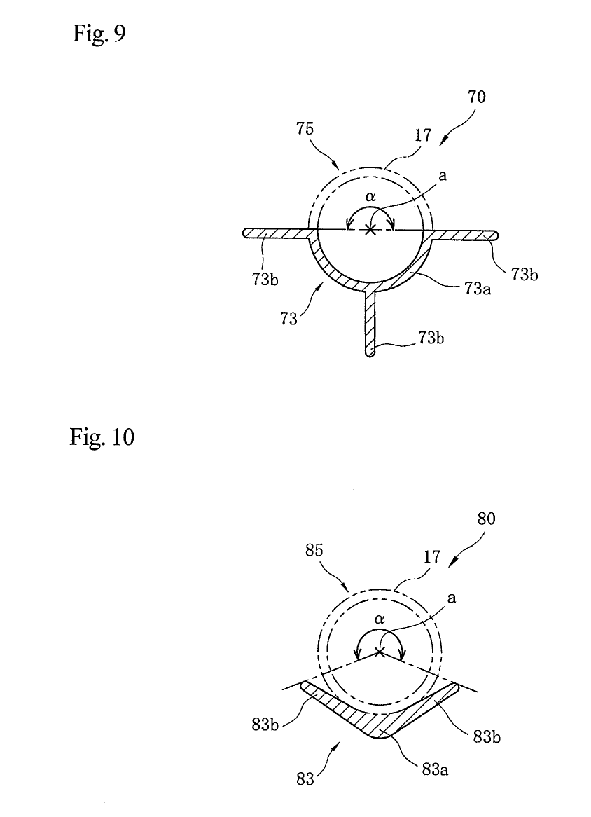

FIG. 9 is a diagram of a seventh embodiment of the tine according to the present invention corresponding to the cross-sectional view cut along the line B-B of FIG. 6. A tine 70 according to this embodiment has a connection 73 provided with three ribs 73b 90 degrees apart on an arc 73a with a semicircle cross-sectional shape. The respective ribs 73b extend radially from the arc 73a to the outside of the virtual hollow cylinder 17. Since the tine 70 of this embodiment has three ribs, it may effectively cut grass roots. An aperture 75 has a circumferential angle α of 180 degrees at the position of the virtual hollow cylinder 17 centered around the central axis a of the virtual hollow cylinder 17.

### Eighth Embodiment

FIG. 10 is a diagram of an eighth embodiment of the tine according to the present invention corresponding to the cross-sectional view cut along the line B-B of FIG. 6. A tine 80 according to this embodiment has a connection 83 with a V-shaped cross section provided with ribs 83b at diagonals symmetrical from a central portion 83a. Formation of the respective ribs 83b so as to circumscribe the outer diameter of the virtual hollow cylinder 17 so as not to enter the virtual hollow cylinder 17 facilitates ejection of the plug. Alternatively, the connection 83 may circumscribe the inner diameter of the virtual hollow cylinder 17. An aperture 85 has a circumferential angle α greater than 180 degrees at the position of the virtual hollow cylinder 17 centered around the central axis a of the virtual hollow cylinder 17.

### Ninth Embodiment

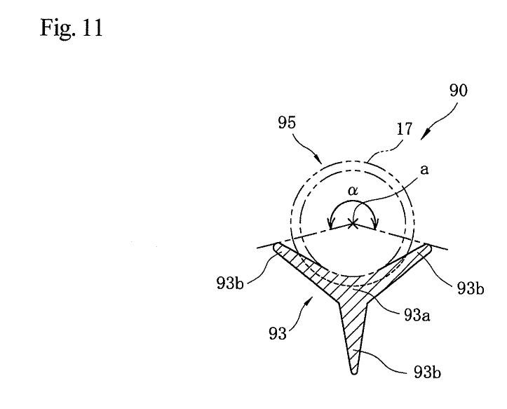

FIG. 11 is a diagram of a ninth embodiment of the tine according to the present invention corresponding to the cross-sectional view cut along the line B-B of FIG. 6. A tine 90 according to this embodiment has a connection 93 with a Y-shaped cross section provided with three ribs 93b forming a Y-shape at intervals of 120 degrees from a central portion 93a. Two of the ribs 93b are formed so as to circumscribe the inner diameter of the virtual hollow cylinder 17, and the remaining one extends from the central axis a toward the outside of the virtual hollow cylinder 17. Moreover, the respective ribs 93b have a V shape gradually narrowing toward the tip, making it easier to cut grass roots. An aperture 95 has a circumferential angle α greater than 180 degrees at the position of the virtual hollow cylinder 17 centered around the central axis a of the virtual hollow cylinder 17.

When the aeration device to which the tines with the structures of the above first through ninth embodiments is attached is operated, each time one of the tines is moved vertically, grass roots are cut as well as the plug that is incorporated and compressed into the tine is scattered on the grass. Since the aperture is enlarged with any one of the tines, the tine does not become clogged with the plug. Furthermore, this sufficiently secures the strength of the connection and lengthens the lifetime of the tine. Moreover, since the shape of the connection of any one of the tines is symmetrical, there is little vibration of the tine during operation, and operative load on the aeration device to which the tine is attached is reduced.

As a result, grass cultivation management is improved, and cultivation of grass is easier and accelerated.

### INDUSTRIAL APPLICABILITY

The tine of the present invention is a tool for performing root cutting essential to grass cultivation management as well as boring, which is a related operation. While root cutting and boring are conventionally carried out separately, use of the tine according to the present invention allows a set of operations in which root cutting and boring are carried out simultaneously. The fact that this set of operations can be carried out at the same time means drastic reduction in grass management. Furthermore, in the boring operation carried out using the tine of the present invention to which are attached ribs over a large section, it may be available as an efficient and high capacity grass management tool.

### DESCRIPTION OF REFERENCES

10: Tine

11: Tip insertion portion

11a: Front edge

11b: Back end

12: Base grip

12a: Thick diameter portion

12b: Thin diameter portion

12c: Front end

13: Connection

13b: Reinforcement

15: Aperture

17: Virtual hollow cylinder

20: Tine

23: Connection

25: Aperture

30: Tine

33: Connection

35: Aperture

40: Tine

43: Connection

45: Aperture

50: Tine

53: Connection

53a: Arc

53b: Rib

55: Aperture

60: Tine

63: Connection

63a: Arc

63b: Rib

70: Tine

73: Connection

73a: Arc

73b: Rib

80: Tine

83: Connection

83a: Central portion

83b: Rib

90: Tine

93: Connection

93a: Central portion

93b: Rib

a: Central axis

D: Diameter

α: Circumferential angle

1. A tine, comprising: a hollow cylindrical tip insertion that is tapered and becomes thinner as it approaches the tip, a base grip apart from the tip insertion, and a connection for connecting between the tip insertion and the base grip; wherein the connection comprises an aperture, and the aperture has, at the position of a virtual hollow cylinder having a maximum diameter portion of the tip insertion extending toward the base grip, a circumferential angle of at least 180 degrees centered around the central axis of the virtual hollow cylinder.

2. The tine of claim 1, wherein the connection is made up of a part of a hollow cylinder connecting between the maximum diameter portion of the tip insertion and the base grip and a reinforcement added to the hollow cylinder.

3. The tine of claim 1, wherein the connection is made by thickening the wall of a portion of a hollow cylinder connecting between the maximum diameter portion of the tip insertion and the base grip.

4. The tine of claim 1, wherein the connection is made by widening a portion of a hollow cylinder connecting between the maximum diameter portion of the tip insertion and the base grip.

5. The tine of claim 2, wherein the reinforcement has at least one rib on the outside of the inner diameter of the hollow cylinder extending from the central axis of the hollow cylinder outward.

6. The tine of claim 1, wherein the connection comprises a central portion on the outside of the inner diameter of the virtual hollow cylinder connecting between the maximum diameter portion of the tip insertion and the base grip, and at least one rib extending radially from the central portion; and the at least one rib is arranged on the outside of the inner diameter of the virtual hollow cylinder.
